(19) United States
(12) Patent Application Publication
(10) Pub. No.: US 2013/0211635 A1
(43) Pub. Date: Aug. 15, 2013

(54) INTERACTIVE DIALOG DEVICES AND METHODS FOR AN OPERATOR OF AN AIRCRAFT AND A GUIDANCE SYSTEM OF THE AIRCRAFT

(71) Applicant: AIRBUS OPERATIONS (SAS), (US)

(72) Inventors: Thierry Bourret, Toulouse (FR); Pascale Louise, Toulouse (FR); Claire Ollagnon, Montpellier (FR); Nicolas Chauveau, Montpellier (FR); Sebastien Giuliano, Toulouse (FR); Sebastien Drieux, Toulouse (FR)

(21) Appl. No.: 13/835,506

(22) Filed: Mar. 15, 2013

Related U.S. Application Data
(63) Continuation-in-part of application No. 13/687,729, filed on Nov. 28, 2012.

(30) Foreign Application Priority Data
Nov. 29, 2011 (FR) 11 60884

(51) Int. Cl. B64C 19/00

(52) U.S. Cl. CPC B64C 19/00
USPC 701/14; 701/3

(57) ABSTRACT

Interactive dialog devices and methods are provided for use by an operator of an aircraft with a guidance system of the aircraft. The dialog devices and methods can include an interaction on a screen that can represent, on the one hand, a playback element indicating the value of a guidance target of the guidance system of the aircraft, and on the other hand, a control element that can be grasped or selected and moved on a display along a path, such as for example a curve, by an operator to modify the value of the guidance target.

### CROSS-REFERENCE TO RELATED APPLICATIONS

This application is a continuation-in-part application from and claims priority to co-pending U.S. patent application Ser. No. 13/687,729 filed Nov. 28, 2012, which relates and claims priority to French Patent Application No. 11 60884 filed Nov. 29, 2011, the entire disclosures of which are incorporated by reference herein.

### TECHNICAL FIELD

The present subject matter relates generally to dialog devices for an aircraft, such as a transport airplane, and more particularly to dialog devices and methods enabling a dialog between an operator of the aircraft, in particular a pilot, and a guidance system of the aircraft.

### BACKGROUND

Airplanes that are provided with a guidance system, either a flight director that computes piloting targets on the basis of guidance targets or an automatic piloting system associated or not with an auto thrust system that makes it possible to follow guidance targets automatically, are typically provided with an item of equipment, for example one called FCU (Flight Control Unit) on airplanes of the AIRBUS type or one called MCP (Mode Control Panel) on airplanes of the BOEING type, that enables a pilot of the airplane to enter guidance targets into the guidance system. Generally, the pilot chooses a guidance target, then he or she controls the engagement (activation) of the associated guidance mode, so that it takes into account either the value entered (in a so-called “selected” mode), or a value computed by the system according to various criteria (in a so-called “managed” mode).

More particularly, the pilot can, with respect to the speed axis, enter a speed (i.e., calibrated airspeed CAS) or Mach target or give control to the system so as to use a speed or Mach target computed on the basis of certain criteria. On the lateral axis, the pilot can enter a heading (HEADING) or route (TRACK) target or give control to the system so as to use the route from the predefined flight plan. On the vertical axis, the pilot can provide a level, follow an axis (e.g., an approach axis), enter an altitude target, indicate how to reach this altitude target by observing a vertical speed or a gradient, by optimizing the climb or descent time while observing an air speed, or by observing a geometrical vertical profile defined by the system according to certain criteria. These targets are taken into account by the guidance system, either directly as soon as their value is modified if the associated mode is active, or after validation (Le., engagement of the associated mode) in the case where another guidance mode is initially engaged. In the latter case, the target is to be preset before its validation.

For each selection of a target to be reached or to be maintained there is a corresponding guidance mode of the airplane. There is one mode engaged for each axis (speed, lateral, vertical) exclusively. As an illustration, on the lateral axis, a heading mode or route mode can be captured or maintained, a trajectory of the flight plan mode can be joined or maintained, or an approach axis on a horizontal plane mode can be captured or maintained. On the vertical axis, an altitude mode can be captured or maintained, a desired altitude can be reached (climb or descent) while observing an air speed mode, a climb or descent can be performed while observing a vertical speed or a gradient, a climb or descent can be performed while observing a geometrical profile or altitude constraints mode, or a vertical plane mode can be used to capture or maintain the approach axis.

A synthetic summary of the behavior of the guidance system (flight director or automatic piloting system, associated or not with an automatic thrust control) is produced, generally, on the screens displaying the primary flight parameters, of PFD (Primary Flight Display) type, on a panel of FMA (Flight Mode Annunciator) type. This synthetic summary reviews, generally, the guidance modes that are engaged (active) on each axis (speed, lateral, vertical), as well as the guidance modes that are armed, that is to say those which have been requested by the pilot and which will be engaged automatically when conditions for engaging the mode are satisfied. As an example, outside the trajectory of the flight plan, in maintain heading mode converging toward the trajectory of the flight plan with the join or maintain the trajectory of the flight plan mode armed, the latter mode is engaged automatically on approaching the flight plan.

In most airplanes with two pilots, the control unit of the guidance system is situated in the center of the cockpit (above the screens showing the flight parameters) so that both pilots can access it. This control unit, for example of FCU type, makes it possible to select guidance targets, to engage the modes associated with a guidance target (render the mode active), or to request the arming of the mode, and to change reference (for example heading rather than route) for a guidance target.

The task of the pilot responsible for the guidance of the airplane is to select the guidance targets and modes. Currently, he or she performs this task through the dedicated control unit (FCU or MCP) which is located between the two pilots, then he or she has to check the selection of his or her targets (values) on the primary flight screen which is located facing him or her (PFD, standing for Primary Flight Display) and/or on the navigation screens (ND, standing for Navigation Display in the lateral plane; VD, standing for Vertical Display in the vertical plane). Then, the guidance is monitored on these screens which indicate the behavior of the guidance. For instance, the guidance can be a summary of the behavior via the synthesis of the modes that are armed and engaged (e.g., shown on an FMA panel), a display of guidance targets (e.g., speed CAS, heading/route, altitude, vertical speed/gradient) and deviations in relation to the current parameters of the airplane (e.g., shown on a PFD screen), or margins in relation to the limits, such as a margin in relation to the minimum operational speed and stall speed (e.g., shown on a PFD screen).

This standard solution presents drawbacks, however, such as the pilot having to select the guidance targets and modes in one place (control unit FCU), then check and monitor the behavior of the airplane in another place (on the playback screens). This involves visual toing and froing and a dispersion of the guidance elements between the control and the playback of the behavior of the system. In addition, the control unit is a physical item of equipment that is costly and difficult to modify (because it is of hardware type), and this control unit is bulky in the cockpit.

### SUMMARY

The present subject matter relates to dialog devices and methods for use by an operator, notably a pilot, of an aircraft for a guidance system of the aircraft, which makes it possible to remedy the above-mentioned drawbacks. To this end, according to the present subject matter, a dialog device which can be installed on the aircraft and which can comprise at least one screen capable of restoring guidance information, is noteworthy in that the screen comprises at least one graphic object which is produced in the form of an interaction element which is associated with at least one guidance target of the guidance system and which represents, on the one hand, a playback element which indicates the value of the associated guidance target of the guidance system and, on the other hand, a control element which can be grasped or selected and moved along a curve by an operator so as to modify the value of the guidance target.

Thus, by virtue of the present subject matter, there is on the screen (e.g., PFD, ND or VD type) at least one interaction element which is associated with a guidance target of the guidance system and which not only makes it possible to restore the value of this guidance target with which it is associated, but also enables an operator to modify this value on the screen. In this way, the control and the monitoring can be combined or colocated.

The present subject matter can be applied to any guidance target used by a guidance system and in particular to the following guidance targets: speed/Mach, heading/route, altitude, vertical speed/gradient. An interaction function (direct) can be obtained on a screen (which was hitherto dedicated only to the playback of the flight parameters and guidance), through an interaction element (namely a graphic object allowing an interaction) associated with a guidance target.

This interaction element can be grasped or selected and moved on a display such as a screen by an operator along a path, such as for example a curve (on a scale for example, which can appear dynamically and contextually when modifying a target) so as to modify the associated guidance target. By way of example, the present subject matter can make it possible to grasp or select an interaction element indicating a heading target, move it along a heading scale (a heading rose for example) to modify the heading target so that the new heading target is taken into account by the guidance system of the aircraft. The path, such as a curve, can be predefined and can be a scale of values displayed by default or an independent curve on which a scale of values can appear dynamically and contextually.

A dialog device according to the present subject matter, of interactive type, thus makes it possible for the pilot to select guidance targets (as well as guidance modes, as specified below) in the same place (screen) where he or she can check and monitor the behavior of the aircraft. This avoids the visual toing and froing and a dispersion of the guidance elements, which exist on the standard dialog devices. The dialog device can further make it possible, in circumstances specified below, to do away with a control unit (e.g., FCU type), which is an item of equipment that is costly, difficult to modify and bulky.

In some aspects, the interaction element can comprise a plurality of states which allow different actions to be implemented. In this case, advantageously, the interaction element can comprise states which allow at least some of the following different actions to be implemented: modifying a guidance target, called selected, which is directly applied by the guidance system; modifying a preset guidance target, which will be applied by the guidance system after validation; engaging a capture or maintain mode for a selected guidance target; and/or engaging a capture or maintain mode for a computed guidance target (called “managed”).

Furthermore, advantageously, the transition from one state to another of the interaction element can be generated by a corresponding movement thereof.

Moreover, in one configuration, a dialog device can comprise a plurality of interaction elements, each of which can be intended for a given guidance target (speed/Mach, heading/route, altitude, vertical speed/gradient) of the guidance system. The use of a plurality of interaction elements, namely an interaction element for each guidance target, on the screens dedicated to the playback of the flight parameters and of the guidance (PFD, ND, VD), makes it possible to directly implement on these screens all the functions of a standard physical control unit, for example of FCU type, and therefore to do away with such a control unit, which represents a significant saving in particular in terms of cost, weight and bulk.

In a particular embodiment, a dialog device can comprise at least one interaction element, which can control at least two different references (speed/Mach, heading/route, vertical speed/gradient) of a guidance target of the guidance system. This interaction element is capable of controlling only one reference at a time, and the selection of one of the references to be controlled depends on the movement of the interaction element (or on the action carried out to make it appear).

Moreover, advantageously, the interaction element can in one aspect not be displayed continuously on the screen, as it can appear by a predetermined action, such as for example by placing a pointer (finger or cursor in particular) on the corresponding graphic object. In the context of the present subject matter, the interaction element can be moved by a direct action. It is however also possible to envisage moving the interaction element by a so-called “lever arm” effect noted further below.

In one particular configuration, the screen can generate a dynamic visual feedback on a predicted trajectory associated with the guidance target, which makes it possible to have directly on the same screen both a way for selecting the guidance target, for restoring its value, and an indication of the effect generated on the trajectory of the aircraft. This embodiment is particularly advantageous operationally, since the pilot can immediately interpret the impact of his or her guidance target modifications on the trajectory, and can do so without the need for any visual toing and froing between a control panel and a playback screen. Furthermore, in this case, advantageously the screen can automatically display at least one characteristic point of the predicted trajectory, and the interaction element can act on the characteristic point(s), thus displayed, of the predicted trajectory to modify them.

The present subject matter can be applied to one or more screens, such as the abovementioned PFD, ND, and VD screens. In a first embodiment of a dialog device, the screen can be a touch screen, and a graphic object is controlled by a direct contact (e.g., finger contact) on the part of the operator on this touch screen. Furthermore, in a second embodiment, a dialog device can comprise, in addition to the screen, a control device, such as a trackball or a touchpad in particular (of the multi-touch type or not), that can be linked to the screen and that enable an operator to control the movement of a cursor on the screen, intended to act on the interaction element provided.

The present subject matter also relates to a guidance system of an aircraft, namely a flight director or an automatic piloting system which may be associated with an automatic thrust system, the automatic piloting system comprising a dialog device such as that mentioned above, to enable a dialog between the guidance system and an operator, notably a pilot, of the aircraft.

These and other objects of the present disclosure as can become apparent from the disclosure herein are achieved, at least in whole or in part, by the subject matter disclosed herein.

### BRIEF DESCRIPTION OF THE DRAWINGS

A full and enabling disclosure of the present subject matter including the best mode thereof to one of ordinary skill in the art is set forth more particularly in the remainder of the specification, including reference to the accompanying figures, in which:

FIG. 1 is the block diagram of a dialog device according to the present subject matter;

FIGS. 2 to 16 schematically illustrate different actions that can be performed in accordance with the subject matter, by acting on an interaction element according to the present subject matter;

FIG. 17 is an exemplary illustration of a vertical airspeed indicator with one primary interaction element and two secondary interaction elements according to an embodiment of the presently disclosed subject matter;

FIG. 18 is an exemplary illustration of a heading scale with one primary interaction element and two secondary interaction elements according to embodiments of the presently disclosed subject matter;

FIG. 19 is an exemplary illustration of the aircraft operator making incremental adjustments to the aircraft's heading on the heading scale according to embodiments of the presently disclosed subject matter; and

FIG. 20 is a block diagram illustrating exemplary device for performing incremental adjustments on a guidance system of an aircraft according to embodiments of the presently disclosed subject matter.

### DETAILED DESCRIPTION

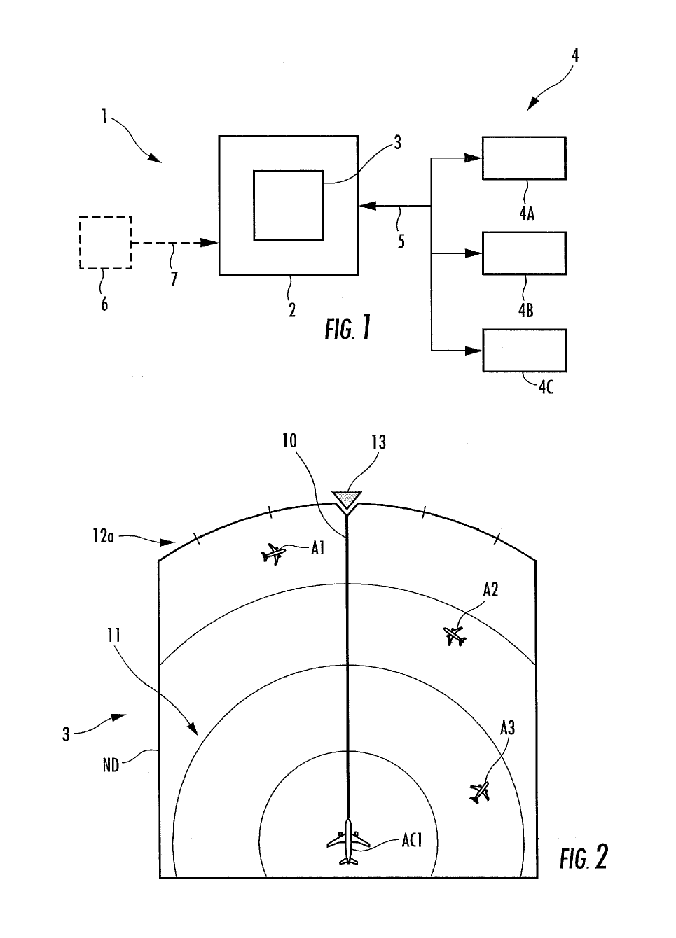

The present subject matter provides devices, systems, and methods that enable a dialog between an operator of an aircraft, in particular a pilot, and a guidance system of the aircraft. In one aspect schematically represented in FIG. 1, for example, the present subject matter provides a dialog device generally designated 1 that can be installed on an aircraft, in particular a transport airplane. In particular, dialog device 1 can be arranged in the cockpit of the aircraft. This dialog device 1 can be configured to allow a dialog between at least one operator of the aircraft (e.g., a pilot) and a standard guidance system of the aircraft.

For this, the dialog device 1 that can be installed on the aircraft can comprise a display system 2 that can comprise at least one screen 3 capable of displaying guidance information of the guidance system 4. The dialog device 1 may comprise one or more screen 3. Specifically, for example, the dialog device 1 can comprise at least one of a piloting screen of Primary Flight Display (PFD) type, a navigation screen of Navigation Display (ND) type in relation to the lateral plane, and/or a navigation screen of Vertical Display (VD) type in relation to the vertical plane.

According to the present subject matter, the screen 3 can comprise at least one graphic object that can be produced in the form of an interaction element 8. This interaction element 8 can be associated with at least one guidance target of the guidance system 4 and can represent, on the one hand, a playback element that indicates the value of this guidance target of the guidance system 4, in conjunction with a scale of values and, on the other hand, a control feature that can be grasped and moved along a curve by an operator, in particular the pilot of the aircraft, so as to modify the value of the guidance target (of the guidance system 4).

To do this, the display system 2 comprising the screen 3 can be linked such as via a link 5 to guidance components 4A, 4B, and 4C of the guidance system 4, so as to be able to provide a communication of information between the two assemblies. The guidance system 4 may comprise, as guidance components, a standard flight director 4A, that can compute piloting targets on the basis of guidance targets, a standard automatic piloting system 4B, which makes it possible to follow guidance targets automatically, and/or a standard automatic thrust system 4C which makes it possible to manage the engines thrust automatically. Thus, by virtue of the dialog device 1 according to the present subject matter, the operator has on the screen 3 at least one interaction element 8 that can be associated with a guidance target of the guidance system 4 and that not only makes it possible to restore the value of this guidance target with which it is associated, but also enables this value to be modified on the screen 3.

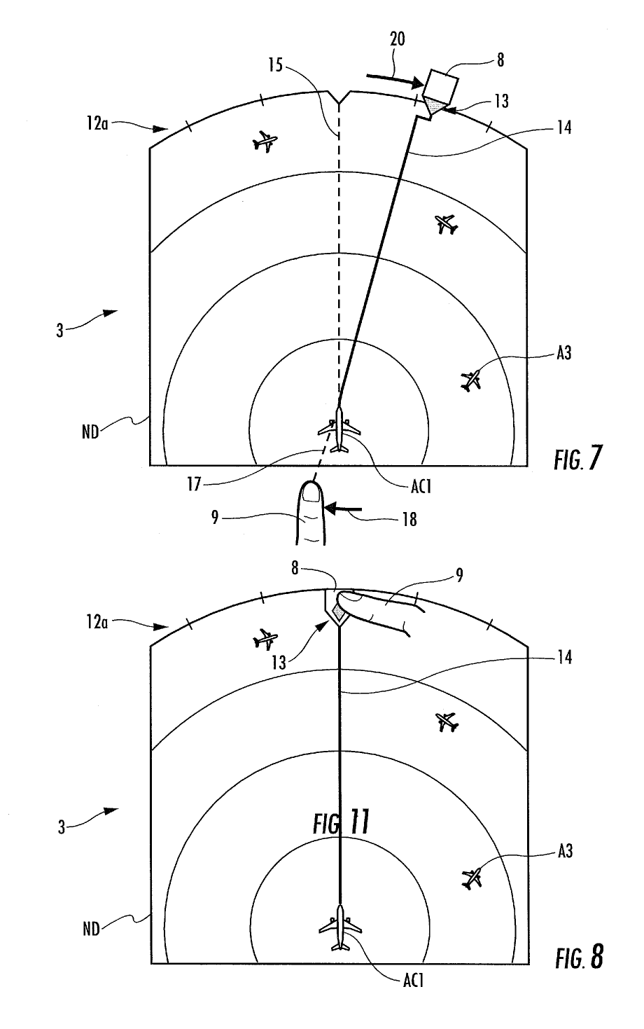

A dialog device 1 according to the present subject matter therefore allows a direct interaction on a screen 3 (which was hitherto dedicated solely to the playback of the flight parameters and guidance), through an interaction element 8 (namely a graphic object allowing an interaction) associated with a guidance target. For example, in a first configuration of the dialog device, the screen 3 can be a touch screen, as represented in FIGS. 2 to 17, and a graphic object can be controlled by the operator by a direct contact on the touch screen 3, such as by a finger contact on the part of the operator, a finger 9 of whom is partially represented in some of these figures.

Furthermore, in a second configuration, dialog device 1 can comprise a control device 6, represented by broken lines in FIG. 1 to show that they correspond to a possible variant, where control device 6 can be linked to the screen 3 (e.g., by a standard link 7 of wired or electromagnetic wave type) and can be actuated manually by an operator so as to control the movement of a standard cursor (not represented) on the screen 3, intended to act on the interaction element 8. Control device 6 may notably comprise a trackball, a computer mouse, and/or a touchpad (of multi-touch type or not).

Regardless of the specific form, control device 6 can be configured to allow an operator to select or grasp and move the interaction element 8 such as on a display along a predefined path such as a curved path or straight path (on a scale for example, which may appear dynamically and contextually when modifying a target) so as to modify the associated guidance target. The path such as a curve for example may be a scale of values that can be displayed by default, as represented in FIGS. 2 to 16, or an independent path on which a scale of values may appear dynamically and contextually.

As an illustration, in FIGS. 2 to 8, the screen 3 can be a navigation screen of Navigation Display (ND) type relating to the lateral plane. Specifically, FIGS. 2 to 8 show the current position AC1 of an aircraft equipped with the device 1, the current positions of surrounding aircraft A1, A2, A3 relative to the current position AC1, a distance scale 11 (in relation to the current position AC1), a first heading scale 12a (e.g., a heading rose) with the value of the current heading being indicated on first the heading scale 12a by a symbol 13, and a continuous line plot 10 which illustrates the lateral trajectory followed by the aircraft. FIGS. 2 to 6 illustrate different successive situations when modifying a guidance target of the guidance system 4, in this case a heading target.

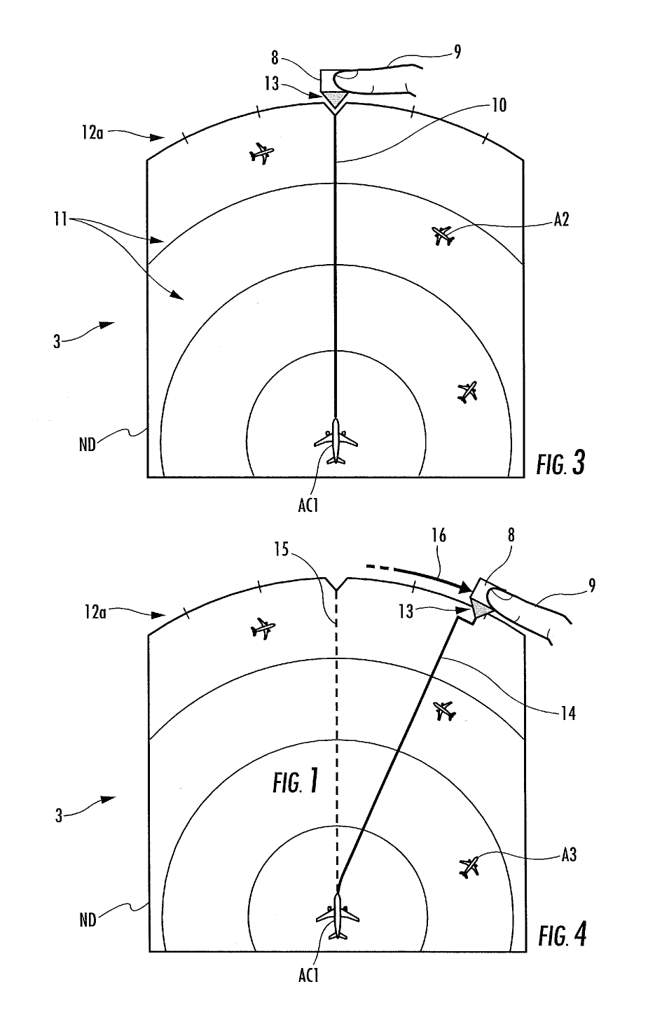

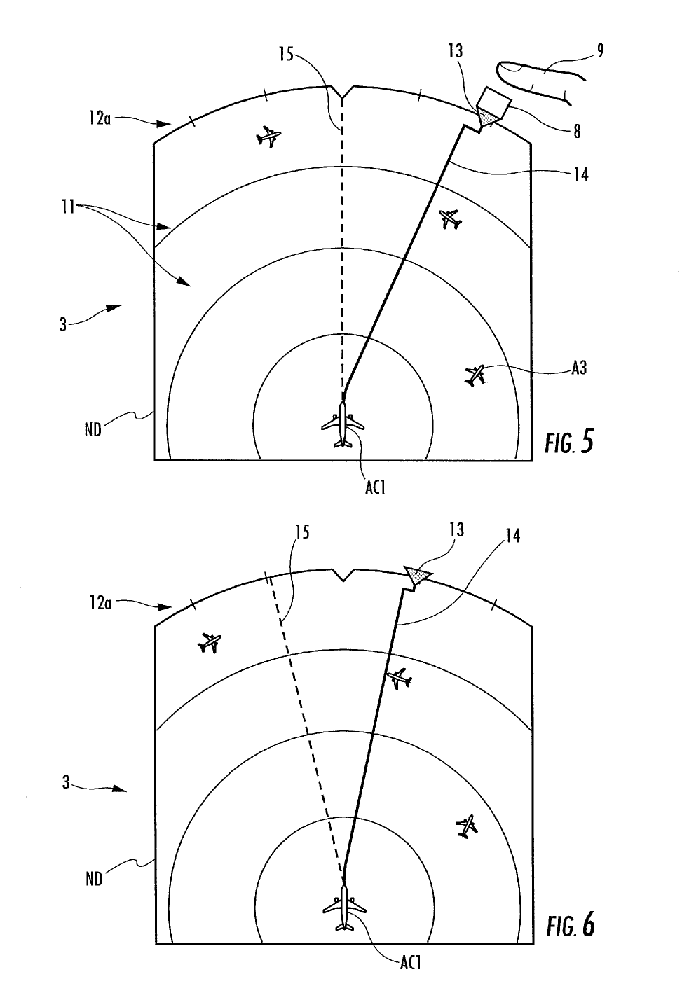

More specifically, FIG. 2 illustrates the initial situation before a modification. In FIG. 3, an operator can place a finger 9 on a graphic object of the screen ND, this finger contact with the screen ND causing an interaction element 8 to appear, intended to modify the heading target of the aircraft. The operator can then move the interaction element 8 with his or her finger 9, as illustrated by an arrow 16 in FIG. 4 so as to modify the heading value. A first broken line plot 15 which illustrates the lateral trajectory according to the flight plan appears, and a second plot 14 which indicates a predicted lateral trajectory follows the interaction element 8, with second and first plots 14 and 15 illustrating trajectory portions in the lateral plane. As shown in FIG. 5, the operator can release his or her finger 9, the modification can be taken into account by the guidance system 4, and the new heading can be illustrated on the first heading scale 12a by the symbol 13. The aircraft can then progressively modify its heading (as illustrated in FIG. 6) to achieve this new heading.

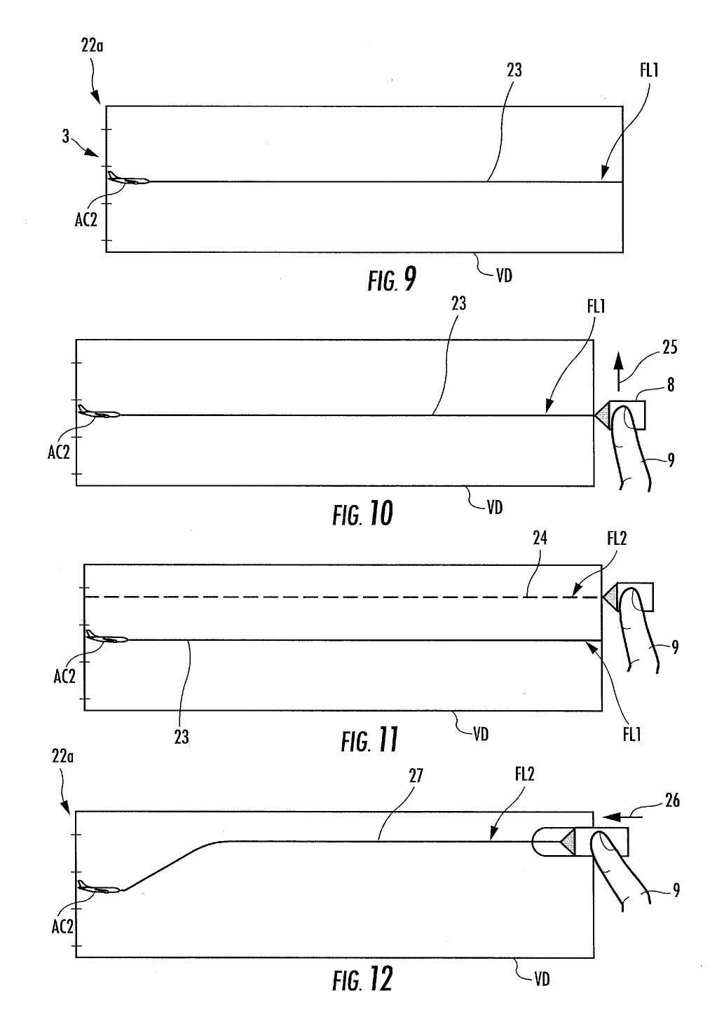

Moreover, by way of illustration, in FIGS. 9 to 16, the screen 3 can be a navigation screen of Vertical Display (VD) type relating to the vertical plane. FIGS. 9 to 16 notably show the current position AC2 of an aircraft equipped with the device 1 and a first altitude scale 22a. FIGS. 9 and 12 illustrate successive situations when modifying a guidance target of the guidance system 4, in this case an altitude target (or flight level), the aircraft can initially be in a maintain altitude mode. More specifically, in FIG. 9, the aircraft can follow a vertical trajectory (plot 23) making it possible to maintain a flight level FL1. As shown in FIG. 10, an operator can bring a finger 9 over a graphic object so as to cause an interaction element 8 to appear, making it possible to modify an altitude target. The operator can move the interaction element 8, as illustrated by an arrow 25, so as to preset a new altitude target. This modification can be made in a presetting mode so that the flight level to be set (which is represented by a broken line plot 24 in FIG. 11) can be highlighted by a different color from that of the plot 23. For example, the plot 23 can be green, and the plot 24 can be yellow. The new altitude target (i.e., to reach a flight level FL2 according to a trajectory 27) can be taken into account by the guidance system 4 after the engagement of a climb mode (maintain speed CAS without altitude constraint), which is controlled by an appropriate movement (illustrated by an arrow 26) of the interaction element 8, as shown in FIG. 12.

FIGS. 13 and 14 also illustrate successive situations when modifying a guidance target of the guidance system 4, in this case an altitude target (or flight level), but in this case the aircraft is initially (not in a maintain altitude mode) but in a climb to a flight level FL3 mode. More specifically, in FIG. 13, the aircraft can follow a vertical trajectory (plot 33) making it possible to reach a flight level FL3. Furthermore, as shown in FIG. 13, an operator can bring a finger 9 over a graphic object so as to cause an interaction element 8 to appear making it possible to modify an altitude target. This interaction element 8 can appear directly at the level of the flight level FL3, and as shown in FIG. 14, the operator can move the interaction element 8, as illustrated by an arrow 35, so as to make a modification to the altitude target which can, in this case, be immediately taken into account by the guidance system 4 (to reach a flight level FL4 according to a trajectory 34).

It is also possible to implement a climb mode to a target altitude by observing a particular constraint, for example an altitude or geometrical profile constraint. As an illustration, in the example of FIG. 15, to reach a flight level FL5, the vertical trajectory 28 can be configured to comply with a plurality of altitude constraints, illustrated respectively by symbols P1, P2 and P3. In particular, the vertical trajectory 28 can be configured to pass under the altitude highlighted by the symbol P1, through the point highlighted by the symbol P2, and over the altitude highlighted by the symbol P3. Moreover, the screen 3 can generate a dynamic visual feedback on a predicted trajectory associated with the guidance target, which makes it possible to have directly on the same screen 3 both a way for modifying the guidance target, for displaying the current value of the guidance target, and an indication of the effect generated on the trajectory of the aircraft by a modification of the guidance target. This can be particularly advantageous operationally, since the pilot can immediately interpret the impact of his or her guidance target modifications on the trajectory, and can do so without requiring any visual toing and froing between a control panel and a playback screen.

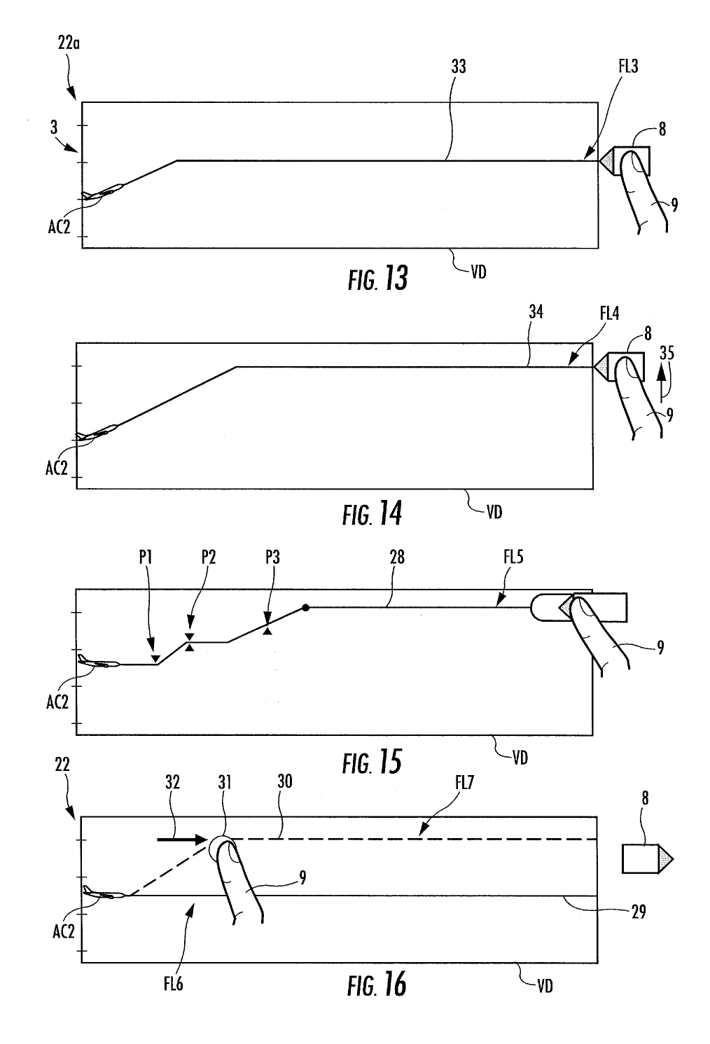

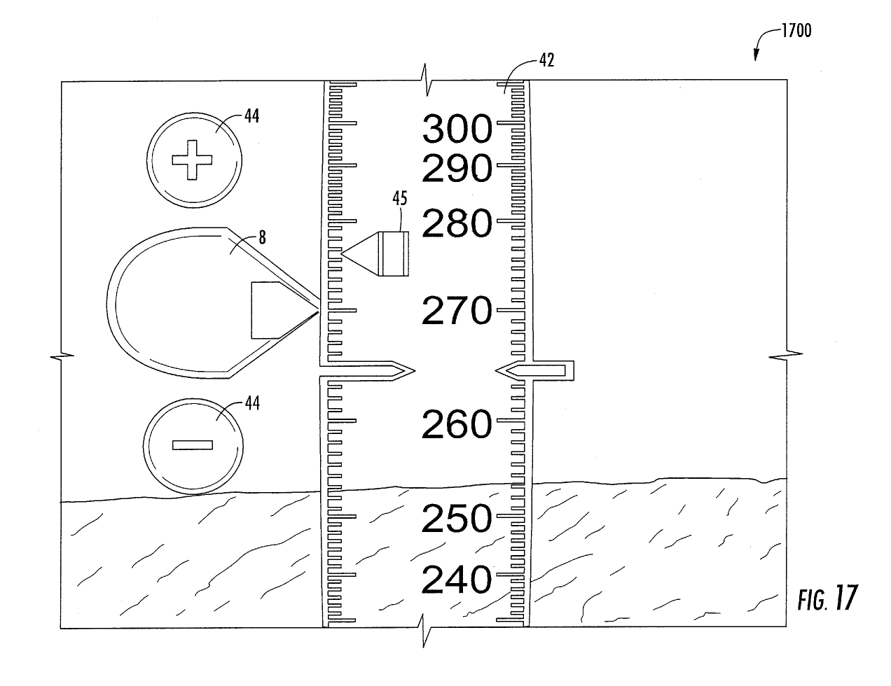

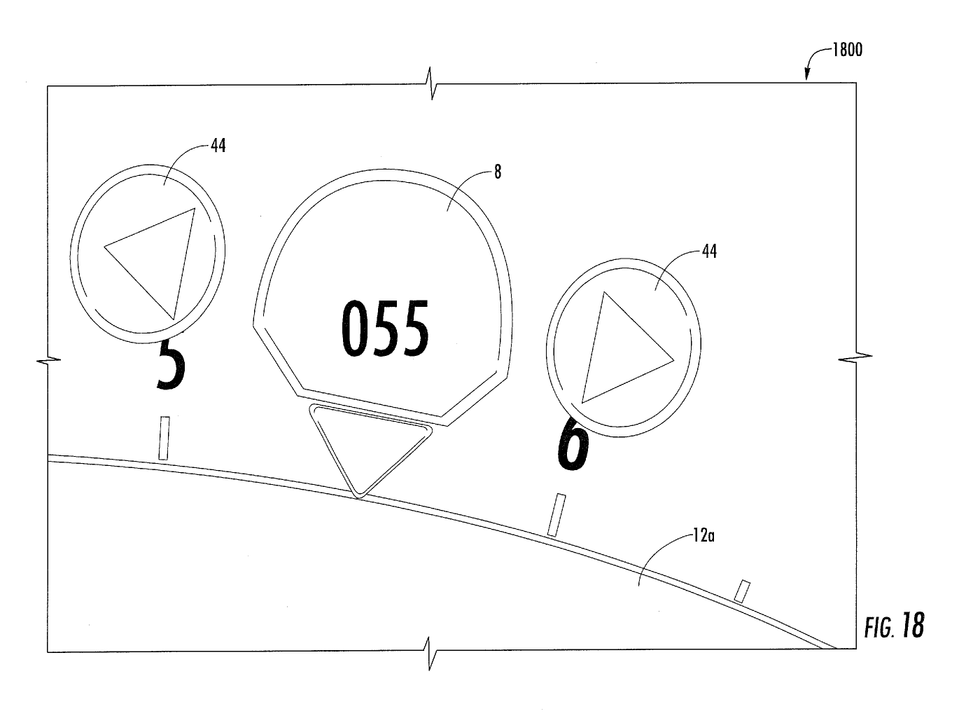

Furthermore, in the latter embodiment, screen 3 may also display, automatically, at least one characteristic point 31 of the predicted trajectory 30 (FIG. 16). As an illustration, for example, screen 3 may display characteristic points (i.e., waypoints) identifying one or more of the point of intersection of its predicted heading/route trajectory with the flight plan, the point of intersection of its predicted heading/route trajectory with the axis of the runway used for a landing, and/or the horizontal distance (in Nm) relative to the aircraft, of the point of capture of the target altitude. In one particular embodiment, the interactions can be extended to the characteristic points of the display of the predicted trajectory of the preceding embodiment. Thus, the interaction element can be capable of acting on the displayed characteristic point or points of the predicted trajectory to modify them.

As an illustration, it is thus notably possible to carry out the following operations. First, on the heading presetting, it can be possible to delay the start of turn by pushing back, along the predicted trajectory for example, the representation (on the ND screen) of the point at which the taking into account of the heading presetting target begins. Similarly, on the gradient/speed presetting, it can be possible to delay the descent/climb start point by an interaction on the graphic representation of this point (e.g., on the VD screen). It can be further possible to modify the vertical speed/gradient target by an interaction on the end-of-climb/descent graphic representation.

As an illustration, as shown in FIG. 16, the aircraft can follow a vertical trajectory (plot 29) relative to a flight level FL6. Furthermore, an operator can cause a vertical trajectory (plot 30) relating to a presetting mode to appear. This trajectory can be highlighted by a different representation (for example a different color) from that of the plot 29. For instance, the plot 29 can be green and the plot 30 can be yellow. The operator can move a characteristic point 31 of the trajectory 30, as illustrated by an arrow 32, so as to act on the target altitude capture point thus modifying the vertical climb speed. The pilot can thus perform an interaction on this characteristic point 31 of the predicted trajectory 30. The new altitude target (to reach the flight level FL7 according to the trajectory 30) can be taken into account by the guidance system 4 after an engagement of a climb mode, which can be controlled by an appropriate actuation of the interaction element 8.

In addition, in yet another configuration of the present subject matter, the interaction element 8 can be configured to function as a primary interaction element, and an aircraft operator can grasp or select and move the primary interaction element 8 on the display to make usual rounded value adjustments to the aircraft's guidance target values. For example, the primary interaction element 8 can be moved on an airspeed indicator 42 of the primary flight display (PFD) to adjust the aircraft's airspeed 5 knots at a time; or by adjusting the aircraft's heading 5° degrees at a time on a heading scale 12 on the aircraft's navigation display (ND); or by adjusting the aircraft's altitude 1000 ft at a time on an altitude scale; or by changing the aircraft's vertical speed 1000 ft per minute at a time on a vertical speed indicator. Grasping or selecting and moving the primary interaction element 8 can be performed through a control device linked to the aircraft's guidance system. For example, the aircraft operator can place a cursor on the primary interaction element 8 and can grasp or select and move the primary interaction element 8 by click and hold the cursor via the control device. The control device can be, for example, a trackball, a computer mouse, and/or a touch pad.

Furthermore, one or more additional secondary interaction elements 44 can be temporary displayed at or near the primary interaction element 8 after the primary interaction element 8 has been moved by the aircraft operator. For example, on the aircraft's heading scale 12, two secondary interaction elements 44 can appear on the right and left side of the primary interaction element 8, after an approximate adjustment on the aircraft's heading has been made.

During normal aircraft operation, guidance target values can be adjusted with rounded values, such as 5 knots for airspeed, 5° degrees for heading, 1000 ft for altitude, or 1000 ft per minute for vertical speed. In some situations however, adjustments to the guidance targets with greater precision (i.e., at values lower than the rounded values) may be desirable. For example, when making an approach to a runway for landing, it may be desired to adjust the aircraft's heading only 1° degree at a time or the aircraft's airspeed 1 knot at a time. Similarly, it may be necessary to adjust the aircraft's altitude only 100 ft at a time when leveling off at low temperature, or adjust the vertical speed 100 ft per minute at a time when performing a non-precision approach.

Furthermore, during turbulences it can be difficult for the aircraft operator to set precise values due to the size of the primary interaction element 8 and the size of the guidance system scales, and the two secondary interaction elements 44 can enable the aircraft operator to easily make incremental adjustments on the aircraft's guidance targets, wherein the incremental adjustments can be smaller in value than the approximate adjustments.

Furthermore, if the scale contains a characteristic value marker 45, which can be for example a computed speed value that provides optimal climbing performance, the minimum selectable speed value or the runway heading value, element 8 can be grasped or selected and moved toward this marker 45. In this case, the element 8 takes the value of the marker, even if this value is not rounded to the nearest approximate value. This additional optional device allow the aircraft operator to directly select a set of pre-defined values identified on the scales by markers without the need of using the secondary interaction elements 44 and therefore having direct access to the pre-defined or pre-computed value although these values may not meet the standard “rounding” values.

In some aspect, the two secondary interaction elements 44 on the heading scale 12 can be configured to perform positive and negative incremental adjustments to the aircraft's heading target value. For example, the aircraft operator can click on or otherwise activate the secondary interaction element 44 displayed to the left of the primary interaction element 8 to make adjustments to the aircraft's heading in relatively smaller increments (e.g., at minus 1° degree at a time) compared to the adjustments enabled by movement of the interaction element 8, via the cursor controlled by the control device 6 linked to the guidance system. Similarly, positive adjustment to the aircraft's heading can be made in small increments (e.g., at 1° degree at a time) by clicking on or otherwise activating the interaction element 44 displayed to the right of the primary interaction element 8.

In another aspect, two secondary interaction elements 44 can be placed on the top and bottom of the primary interaction element 8 on the airspeed indicator 42 of the PFD for making incremental adjustments to the aircraft's airspeed. For example, the top secondary interaction element 44 can be labeled “+” and the aircraft operator can click on it to increase the aircraft's airspeed by a relatively small value (e.g., 1 knot at a time) compared to the adjustments enabled by movement of the interaction element 8. Similarly, the bottom secondary interaction element 44 can be labeled “−” and clicking on it can decrease the aircraft's airspeed by a small amount (e.g., 1 knot at a time).

In addition, after an approximate adjustment has been made to an aircraft's guidance target, that approximate guidance target value 46 can remain visible on the screen to the aircraft operator as a reference for making subsequent incremental adjustments.

FIG. 17 depicts an exemplary illustration generally designated 1700 of a vertical airspeed indicator 42 with one primary interaction element 8 and two secondary interaction elements 44. As shown in FIG. 17, the two secondary interaction elements 44 can be placed on top and bottom of the primary interaction element 8. In some aspect, directional indicia can be displayed on the display screen and be associated with the secondary interaction elements 44.

For example, the top secondary interaction element 44 can be labeled “+” and the aircraft operator can click on it to increase the aircraft's speed by a relatively small amount (e.g., 1 knot at a time). The bottom secondary interaction element 44 can be labeled “−” and clicking on it can decrease the aircraft's airspeed by a relatively small amount (e.g., 1 knot at a time).

FIG. 18 depicts an exemplary illustration generally designated 1800 of a heading scale 12 with one primary interaction element 8 and two secondary interaction elements 44. As shown in FIG. 18, the two secondary interaction elements 44 can be placed to the left and right of the primary interaction element 8. In some aspect, the aircraft operator can click on the secondary interaction element 44 displayed to the left of the primary interaction element 8 to make adjustments to the aircraft's heading in relatively small increments (e.g., at minus 1° degree at a time), and clicking on the secondary interaction element 44 displayed to the right of the primary interaction element 8 can adjust the aircraft's heading in relatively small increments (e.g., at positive 1° degree at a time).

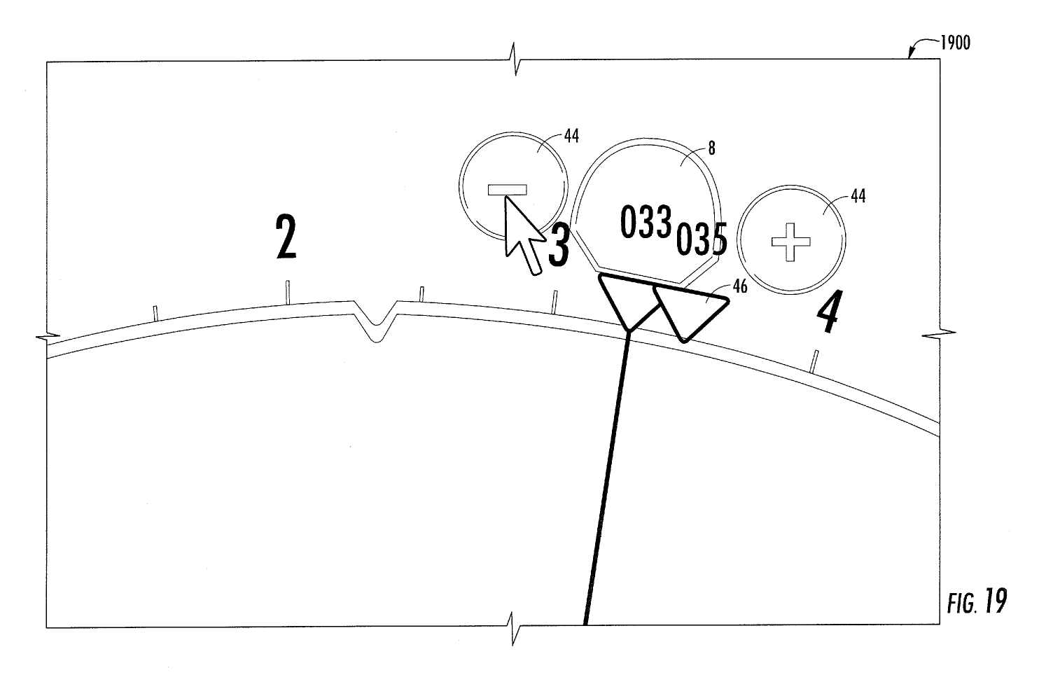

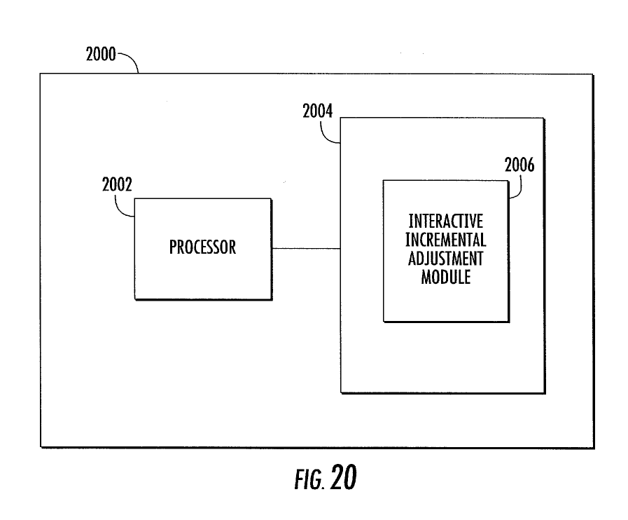

FIG. 19 depicts an exemplary illustration generally designated 1900 of the aircraft operator making incremental adjustments to the aircraft's heading on the heading scale 12. As shown in FIG. 19, an approximate adjustment on the aircraft's heading can be made by grasp or select and move the primary interaction element 8 to the 035° degree mark. The aircraft operator can then click on the secondary interaction element 44 displayed to the left of the primary interaction element 8 and labeled “−” for example to adjust the aircraft's heading 1° degree at a time to the 033° degree mark, while the 035° degree mark can remain displayed on the scale as a reference point to the aircraft operator.

FIG. 20 is a block diagram illustrating an exemplary device generally designated 2000 for performing incremental adjustments on a guidance system of an aircraft in accordance with embodiments of the subject matter described herein. Referring to FIG. 20, the system 2000 can comprise a hardware-based processor 2002 and a memory unit 2004. Memory unit 2004 can contain one or more software- or firmware-based modules for execution by processor 2002. For example, memory unit 2004 can contain an interactive incremental adjustment module 2006, which can be configured to perform approximate adjustments on a scale via a first interaction with a primary interaction element to modify at least one guidance target value of the guidance system, display at least one secondary interaction element, and perform incremental adjustments to the at least one guidance target value on the scale via a second interaction with the at least one secondary interaction element.

The present subject matter can be embodied in other forms without departure from the spirit and essential characteristics thereof. The embodiments described therefore are to be considered in all respects as illustrative and not restrictive. Although the present subject matter has been described in terms of certain preferred embodiments, other embodiments that are apparent to those of ordinary skill in the art are also within the scope of the present subject matter.

What is claimed is:

1. A method for performing one or more incremental adjustments on a guidance system of an aircraft, comprising:
performing an approximate adjustment on a scale via a first interaction with a primary interaction element to modify at least one guidance target value of the guidance system;
displaying at least one secondary interaction element; and
performing one or more incremental adjustments to the at least one guidance target value on the scale via a second interaction with the at least one secondary interaction element.

2. The method of claim 1, wherein the approximate adjustment is larger in value than the incremental adjustment.

3. The method of claim 1, wherein the primary interaction element is a control element that can be grasped or selected and moved by an operator.

4. The method of claim 3, wherein performing approximate adjustments comprises grasping or selecting and moving the primary interaction element along the scale.

5. The method of claim 1, further comprising of displaying at least one directional indicia associated with the at least one secondary interaction element.

6. The method of claim 1, wherein displaying at least one secondary interaction element comprises displaying a first secondary interaction element configured for making positive incremental adjustments on the scale, and displaying a second secondary interaction element configured for making negative incremental adjustments on the scale.

7. The method of claim 1, wherein performing incremental adjustments comprises grasping or selecting and moving the primary interaction element near to an at least one characteristic value marker.

8. The method of claim 1, wherein one or both of performing approximate adjustments or performing incremental adjustments comprises controlling the movement of a cursor, via a control device linked to the guidance system, to act on one or both of the primary or secondary interaction elements.

9. The method of claim 8, wherein performing incremental adjustments comprises activating the at least one secondary interaction element using the cursor.

10. A device for performing incremental adjustments on a guidance system of an aircraft comprising:
a processor configured to execute an interactive incremental adjustment module;
wherein the interactive incremental adjustment module is configured to perform approximate adjustments on a scale via a first interaction with a primary interaction element to modify at least one guidance target value of the guidance system, display at least one secondary interaction element, and perform incremental adjustments to the at least one guidance target value on the scale via a second interaction with the at least one secondary interaction element.

11. The device of claim 10, wherein the approximate adjustment is larger in value than the incremental adjustment.

12. The device of claim 10, wherein the primary interaction element is a control element configured to be grasped or selected and moved by an operator.

13. The device of claim 12, wherein the first interaction is configured to be grasped or selected to move the primary interaction element along the scale.

14. The device of claim 10, wherein the at least one secondary interaction element is configured to display at least one directional indicia.

15. The device of claim 10, wherein the at least one secondary interaction element comprises a first secondary interaction element configured for making positive incremental adjustments on the scale, and a second secondary interaction element configured for making negative incremental adjustments on the scale.

16. The device of claim 10, wherein the first interaction is configured to be grasped or selected to move the primary interaction element near to an at least one characteristic value marker.

17. The device of claim 10, further comprising a control device linked to the guidance system and configured to control the movement of a cursor to act on one or both of the primary or secondary interaction elements.

18. The device of claim 17, wherein the second interaction comprises the at least one secondary interaction element be configured for activation using the cursor.
